(19) United States
(12) Patent Application Publication
(10) Pub. No.: US 2011/0048463 A1
(43) Pub. Date: Mar. 3, 2011

(54) SPRAYING DEVICE

(75) Inventors: JAN MOMSEN, Flensburg (DE); Bernd Hansen, Rantrum (DE); Karl-Heinz Messer, Schleswig (DE); Lothar Aschenbrenner, Roding (DE)

(73) Assignee: KRONES AG, Neutraubling (DE)

(21) Appl. No.: 12/870,083

(22) Filed: Aug. 27, 2010

(30) Foreign Application Priority Data
Sep. 1, 2009 (DE) 102009039585.7

(51) Int. Cl. B08B 9/093

(52) U.S. Cl. 134/22.18; 134/170

(57) ABSTRACT

A spraying device for a container cleaning system having a container conveyor by means of which containers are transported with their opening facing downwards is described, with the spraying device having spray nozzles acting from the bottom onto the container. To clean the outer side of the containers, the spraying device contains an external spray nozzle directed to the outer surface of the container.

### CROSS-REFERENCE TO RELATED APPLICATION

The present application claims the benefit of priority of German Application No. 102009039585.7, filed Sep. 1, 2009. The entire text of the priority application is incorporated herein by reference in its entirety.

### FIELD OF THE DISCLOSURE

The disclosure relates to a spraying device of the type used for cleaning containers in beverage bottling operations.

### BACKGROUND

A spraying device of this type is known from DE 43 30 335 A1. The known spraying device is employed for bottle cleaning systems in which a conveyor conveys the bottles head first, i.e. with the opening facing downwards, through the cleaning system and over the spraying device. The spraying device contains a plurality of nozzles which track the spray jet along the conveying direction of the bottles by cam control. The nozzles are the outlet openings of through bores through a nozzle shaft that is rotatably seated on a manifold containing a through bore in communication with a spraying channel and with the nozzle shaft. The nozzle shaft rotates over the manifold bore, so that every time the nozzle bore is aligned with the manifold bore, a spray jet is generated which enters the bottle through the opening of the bottle and cleans it inside.

The outside cleaning of the bottles is either effected by various immersion baths, or by liquids striking from above, i.e. onto the bottom of the bottle, in particular in the rinsing stage. However, it showed that with this outside cleaning, the mouth of the bottles cannot always be cleaned in a satisfactory manner.

### SUMMARY OF THE DISCLOSURE

It is thus an aspect of the disclosure to improve the outside cleaning of containers, in particular in the region of the opening mouth.

By the inventive departure from spraying from the upper side, it is achieved in a constructively simple manner that the mouth of containers can be better cleaned as it can be optimally reached by the spray jet from the bottom.

The combination of inside cleaning with outside cleaning by means of combined internal and external nozzles is particularly advantageous. Internal and external nozzles are preferably seated on one common nozzle shaft and can thus be driven by means of one single apparatus, preferably a cam control. For optimal cleaning, two external spray nozzles are preferred which preferably operate laterally reversed with respect to each other.

Prefabricated nozzle pairs of one external and one internal spraying nozzle each, which are each provided on a common nozzle shaft, are particularly simple as to their construction and manufacture. If these spray nozzle pairs are then arranged to be laterally reversed with respect to each other, two spray jets directed to the interior of the container and two spray jets directed to opposite outer surfaces result.

By the method according to the disclosure, essentially better outside cleaning is achieved in a constructively simple manner. Here, outside cleaning can be even further improved by adjusting the spray jet from the external spray nozzle such that it reaches beyond the axial length of the container, falls back from above onto the bottom of the container and then, following the contour of the bottle's outer wall, flows downwards again, so that opposite water streams are also formed in the region of the mouth and have a good cleaning effect.

### BRIEF DESCRIPTION OF THE DRAWINGS

The disclosure will be described more in detail below with reference to the drawings. In the drawings:

FIG. 1 shows a view of a spraying device according to the disclosure in the conveying direction,

FIG. 2 shows a side view of the spraying device according to the disclosure along the section II-II,

FIGS. 3a to 3e show various spraying stages while a container is passing through the spraying device.

### DETAILED DESCRIPTION OF THE PREFERRED EMBODIMENT

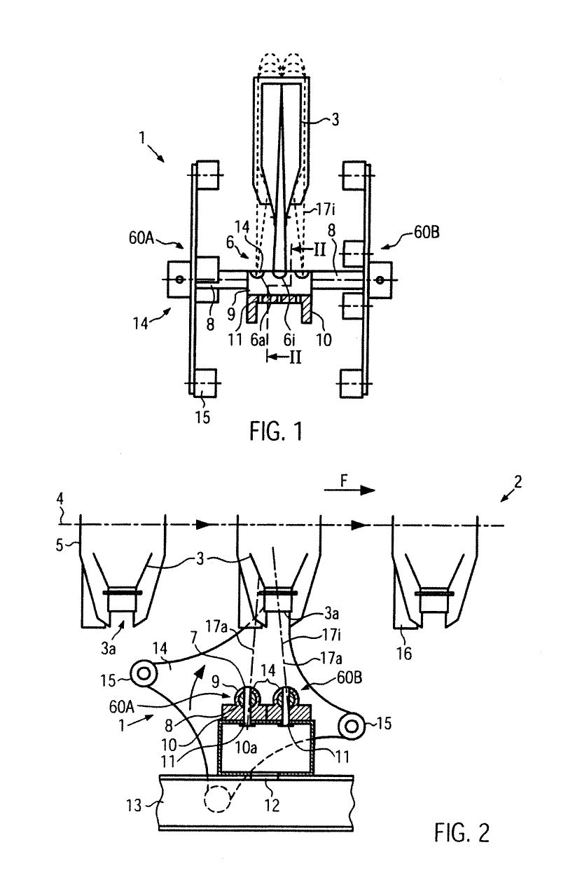

From FIGS. 1 and 2, one can take a first embodiment of a spraying device 1 which forms a part of a cleaning system 2 for containers 3 , where here bottles are represented. The cleaning device 2 contains a conveyor 4 which moves through the system in the conveying direction F. The conveyor 4 contains holders 5 for the containers 3 by means of which the containers 3 are transported head first, i.e. with the opening 3a facing downwards. In the represented embodiment, the holders 5 are bottle baskets.

The spraying device 1 contains a plurality of nozzles 6 which are located adjacent transversely to the conveying direction F such that the spray jet can reach the container 3 from each of the nozzles 6.

The nozzles 6 contain at least one external spray nozzle 6a and at least one internal spray nozzle 6i. The external spray nozzle 6a and the internal spray nozzle 6i are embodied as through bores 7 in a nozzle shaft 8 which is rotatably mounted in a bearing sleeve 9 seated on a manifold 10. The manifold 10 contains through bores 11 in a manifold chamber 10a, the through bores 11 being embodied and arranged such that they become aligned with the nozzle bores 7 while the nozzle shaft 8 is rotated. Preferably, the diameter of the manifold bores 11 is larger than that of the nozzle bores 7, so that the nozzle bores 7 remain connected to the manifold chamber 10a over a certain area of the angle of rotation. The manifold chamber 10a is in communication with a manifold channel 13 via a supply opening 12, the manifold channel 13 supplying all spraying means. In the desired area of the angle of rotation, the bearing sleeve 9 is provided with an opening 14 through which a spray jet can be emitted.

In the represented embodiment, one internal spray nozzle 6i and one external spray nozzle 6a each are arranged on a common rotating shaft 8. The rotating shaft 8 is driven to be rotated, preferably via a cam control 14. The cam control 14 contains cams 15 which are actuated by a catch 16 of the holder 5 while the containers 3 are passing. Thereby, the cam control 14 is rotated and rotates the rotating shaft 8. By the rotation of the rotating shaft 8, the nozzle bores 7 are aligned and misaligned with the through bores 11 of the manifold 10 and are thereby supplied with spraying liquid, whereby each of the nozzles 6 generates a spray jet 17. The nozzles 6 that are seated on a common nozzle shaft 8 can be identical or different with respect to the angular position in the circumferential direction around the rotating shaft 8 and/or also with respect to their angular position in the axial direction to the rotating shaft 8 and/or the arrangement next to or below the trajectory of the opening 3a. However, in any case, one of the nozzles, the external spray nozzle 6a, should generate a spray jet 17a directed to the outer surface of the container at or above the mouth, and the internal spray nozzle 6i should generate a spray jet 17i that can enter the mouth 3a.

In the represented embodiment, two spray nozzle pairs 60A and 60B are provided which are each embodied with a nozzle shaft 8, an internal spray nozzle 6i, an external spray nozzle 6a and a cam control 14. The spray nozzles 6a, 6i are arranged to be spaced apart transversely to the conveying direction F, however, they have the same angular orientation. For saving space, both pairs are arranged one behind the other and laterally reversed in the conveying direction F (FIG. 2), so that each of the external nozzles 6a of the two pairs 60A and 60B strokes over one of the two opposite container halves. The second internal nozzle 6i of one of the two pairs 60A, 60B is not absolutely necessary, but it can be embodied such that it cooperates, for example, with the second internal spray nozzle in a manner described in DE 43 30 335 A1. If a holder by means of which the containers 3 can be rotated is used, only one pair of an external and internal spray nozzle is required.

Depending on the type and dimension of the containers to be cleaned, the dimensions of the nozzles can also be varied, in the represented embodiment, the distance between the nozzle bores on a nozzle shaft is approx. 20 mm. Furthermore, it is possible that one or all nozzles 6 consist of two nozzle bores 7 which are arranged offset with respect to each other by 90° around the axis of the nozzle shaft 8, so that per rotation of the nozzle shaft, not only two, but four spray jets can be generated.

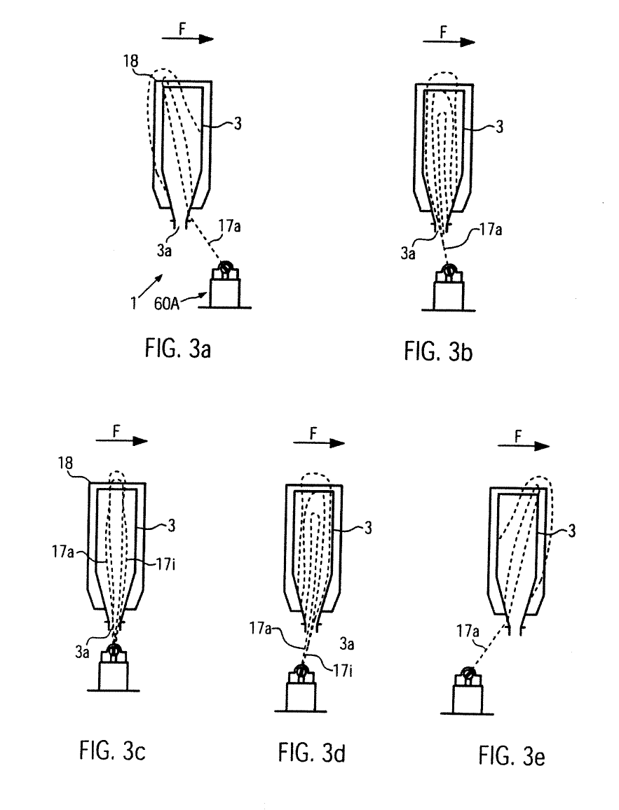

The nozzles can be actuated in many different ways; one embodiment will be illustrated below with reference to FIGS. 3a to 3i. In the following figures, the internal jets 17i are marked with solid lines, and the external jets 17a are marked with dot-dash lines.

FIG. 3a shows the beginning of the spraying of a container 3 that is entering the spraying device 1. For the sake of simplicity, only one spray nozzle pair 60A of two spray nozzles 6a, 6i situated one behind the other perpendicular to the drawing plane are shown here. While the container 3 enters the spraying device 1, it is first hit by external jets 17a into which the container 3 runs. The spray jet 17a hits the outer wall of the container just above the opening 3a and flows upwards over the outer side of the container 3. The power of the spray jet is adjusted such that the spray jet 17a reaches over the axial length of the container 3 and passes over the bottom, indicated by a cloud of droplets 18. The droplets fall back to the bottom of the container 3 and then flow down at its outer wall until they drip off in the region of the opening 3a and thus rinse off all released contaminations. The container 3 moves further in the conveying direction F until it reaches a point where the opening 3a can be reached by the internal nozzle 6i. Then, the internal nozzle 6i starts to spray and directs the jet inside the container 3. Cleaning of the inner wall begins. The external spray jet 17a is maintained and runs essentially in parallel to the internal spray jet 17i in the represented embodiment.

In FIG. 3c, the central position is reached in which the spray jets 17i and 17a are directed essentially vertically upwards, where the cloud of droplets 18 of the external spray jet 17a is largest.

In FIG. 3d, the internal spray jet 17i is on the verge of leaving the opening 3a, where it is advantageously switched off subsequently. The external jet 17a can, as is shown in FIG. 3e, still remain active.

The operating process of the spraying device with two spray nozzle pairs 60A, 60B is analogous, however, as the pairs 60A, 60B are offset by a certain distance in the conveying direction F, the actuation intervals are also offset by a suited control.

In variation to the described and drawn embodiment, in case of non-rotating containers, two external spray nozzles can be optionally combined with one single internal spray nozzle on a common rotating shaft to achieve a complete all-around cleaning, moreover, the spray jet 17a and 17i can spray synchronously. The control of the shown spray nozzles can be effected by other means, moreover, spray nozzles of a different construction can be employed.

1. Spraying device for a cleaning system for containers, comprising a container conveyor by means of which the containers are transported with their mouth facing downwards, and having spray nozzles acting on the container from the bottom, and an external spray nozzle acting on the outer surface of the container.

2. Spraying device according to claim 1, wherein next to a first internal spray nozzle directed to spray through the mouth, at least one second external spray nozzle is directed to the outer surface of the container.

3. Spraying device according to claim 2, wherein the external and the internal spray nozzle are arranged on a common nozzle shaft.

4. Spraying device according to claim 2, wherein the external and the internal spray nozzle are each embodied as at least one through bore through the nozzle shaft.

5. Spraying device according to claim 3, wherein the nozzle shaft is driven by a cam control.

6. Spraying device according to claim 1, wherein two external spray nozzles are provided.

7. Spraying device according to claim 6, wherein the external spray nozzles operate laterally reversed with respect to each other.

8. Spraying device according to claim 3, and a first and a second spray nozzle pair consisting each of one external and one internal spray nozzle, which are each arranged on a separate nozzle shaft.

9. Spraying device according to claim 8, wherein the spray nozzle pairs are arranged to be laterally reversed with respect to each other.

10. Method for cleaning containers which are conveyed through a spraying device according to claim 1, and with their mouth facing downwards, and striking an external spray jet against the outer surface of the container from the bottom.

11. Method according to claim 10, and wherein next to an internal spray jet which is directed from the bottom through the opening into the interior of the container, and directing at least one external spray jet from the bottom to the outer surface of the container.

12. Method according to claim 10, and wherein, the external spray jet reaches beyond the axial length of the container.
